(19) United States
(12) Patent Application Publication
(10) Pub. No.: US 2023/0354899 A1
(43) Pub. Date: Nov. 9, 2023

(54) AEROSOL GENERATION SYSTEM

(71) Applicant: Nicoventures Trading Limited, LONDON (GB)

(72) Inventor: Luke WARREN, London (GB)

(21) Appl. No.: 18/245,203

(22) PCT Filed: Sep. 13, 2021
(86) PCT No.: PCT/EP2021/075117

§ 371 Date: Mar. 14, 2023

(30) Foreign Application Priority Data
Sep. 14, 2020 (GB) 2014445.7

(51) Int. Cl. A24F 40/465; A24F 40/20; H05B 3/26; F16L 59/065

(52) U.S. Cl. CPC A24F 40/465; A24F 40/20; F16L 59/065; H05B 3/26

(57) ABSTRACT

A non-combustible aerosol provision device for heating aerosol-generating material to volatize at least one component of the aerosol-generating material is disclosed. One such device includes a first heating element at least partially defining a heating zone for receiving at least a portion of a consumable comprising the aerosol-generating material. The device has a second heating element extending from an axial end of the first heating element beyond the heating zone. The device also has a thermal insulator including an inner wall; an outer wall; and an insulation region bound by the inner wall and the outer wall, wherein the insulation region is evacuated to a lower pressure than an exterior of the insulation region. The thermal insulator is arranged to extend around at least part of the first heating element and at least part of the second heating element.

### PRIORITY CLAIM

The present application is a National Phase entry of PCT Application No. PCT/EP2021/075117, filed Sep. 13, 2021, which claims priority from GB Application No. 2014445.7, filed Sep. 14, 2020, each of which hereby fully incorporated herein by reference.

### TECHNICAL FIELD

The present disclosure relates to an aerosol provision device, a method of generating an aerosol using the aerosol provision device, and an aerosol-generating system comprising the aerosol provision device.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure, there is provided a non-combustible aerosol provision device for heating aerosol-generating material to volatilize at least one component of the aerosol-generating material, the device comprising: a first heating element at least partially defining a heating zone for receiving at least a portion of a consumable comprising the aerosol-generating material; a second heating element extending from an axial end of the first heating element beyond the heating zone; a thermal insulator comprising: an inner wall; an outer wall; and an insulation region bound by the inner wall and the outer wall, wherein the insulation region is evacuated to a lower pressure than an exterior of the insulation region; the thermal insulator being arranged to extend around at least part of the first heating element and at least part of the second heating element.

According to a second aspect of the present disclosure, there is provided a non-combustible aerosol provision device for heating aerosol-generating material to volatilize at least one component of the aerosol-generating material, the device comprising: a first heating element at least partially defining a heating zone for receiving at least a portion of a consumable comprising the aerosol-generating material; a second heating element extending from an axial end of the first heating element beyond the heating zone; a thermal insulator comprising: an inner wall; an outer wall; and an insulation region bound by the inner wall and the outer wall, wherein the insulation region is evacuated to a lower pressure than an exterior of the insulation region, and wherein the inner wall comprises at least a part of each of the first heating element and the second heating element.

According to a third aspect of the present disclosure, there is provided a non-combustible aerosol provision system, comprising: an apparatus according to the first or second aspects of the present disclosure; and aerosol-generating material located at least partially within the heating zone of the first and/or second heating elements, in use.

Further features and advantages of the disclosure will become apparent from the following description of various embodiments of the disclosure, given by way of example only, which is made with reference to the accompanying drawings.

### BRIEF DESCRIPTION OF THE DRAWINGS

Embodiments of the disclosure will now be described, by way of example only, with reference to the accompanying drawings, in which:

FIG. 1 shows a schematic cross-sectional view of an example aerosol provision device.

FIG. 2 shows a schematic view of an example thermal insulation arrangement for use in the device of FIG. 1, along with another component of the device of FIG. 1.

FIG. 3 shows a cross-sectional view of the example thermal insulation arrangement along the line A-A of FIG. 2, along with another component of the device of FIG. 1.

FIG. 4 shows a more detailed schematic view of region B indicated in FIG. 3.

FIG. 5 shows a schematic view of another example thermal insulation arrangement for use in the device of FIG. 1, along with other components of the device.

FIG. 6 shows a cross-sectional view of the example thermal insulation arrangement along the line C-C of FIG. 5, along with other components of the device.

FIG. 7 shows a more detailed schematic view of region D indicated in FIG. 6.

### DETAILED DESCRIPTION

As used herein, the term “aerosol-generating material” includes materials that provide volatilized components upon heating, typically in the form of an aerosol. Aerosol-generating material includes any tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

Apparatus is known that generates aerosol from an aerosol-generating material using an aerosol generator. One particularly common way of generating aerosol is by heating the aerosol-generating material. In such an apparatus, the aerosol generator is a heater which heats aerosol-generating material to volatilize at least one component of the aerosol-generating material, typically to form an aerosol which can be inhaled, without burning or combusting the aerosol-generating material. Such apparatus is sometimes described as an “aerosol provision device”, a “heat-not-burn device”, a “tobacco heating product device” or a “tobacco heating device” or similar. Similarly, there are also so-called e-cigarette devices, which typically vaporize an aerosol-generating material in the form of a liquid, which may or may not contain nicotine. The aerosol-generating material may be in the form of or be provided as part of a rod, cartridge or cassette or the like which can be inserted into the apparatus. An aerosol generator for volatilizing the aerosol-generating material may be provided as a “permanent” part of the apparatus or could be combined with the aerosol-generating material in a replaceable or consumable component. In the present disclosure, the focus will be on an aerosol generator which is a heater; however, it should be understood that alternative ways of generating aerosol from an aerosol-generating material are also available.

An aerosol provision device can receive an article comprising aerosol-generating material for heating. An “article” in this context is a component that includes or contains, in use, the aerosol-generating material, which is heated to volatilize the aerosol-generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article. Alternatively, aerosol-generating material can simply be located in a free or unconstrained manner in a heating chamber of a device; loose leaf tobacco, for example, could be used in this way.

Induction heating is a process in which an electrically conductive object is heated by penetrating the object with a varying magnetic field. The process is described by Faraday’s law of induction and Ohm’s law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole re-orientation causes heat to be generated in the magnetic material.

When an object is both electrically conductive and magnetic, penetrating the object with a varying magnetic field can cause both Joule heating and magnetic hysteresis heating in the object. Moreover, the use of magnetic material can strengthen the magnetic field, which can intensify the Joule and magnetic hysteresis heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

To facilitate formation of an aerosol in use, aerosol-generating material for aerosol provision devices (e.g. tobacco heating products) usually contains more water and/or aerosol-generating agent than the aerosol-generating material within combustible smoking articles. This higher water and/or aerosol-generating agent content can increase the risk of condensate collecting within the aerosol provision device during use, particularly in locations away from the heating unit(s). It has been found that condensate production can be exacerbated by relatively rapid heating, such as that achieved by induction heating systems.

This problem may be greater in devices with enclosed heating chambers. In such devices, the heating chamber may be fluidically connected with the exterior of the device by a conduit, for example an inlet or outlet conduit. There is a particular risk that condensate collects within such conduits because the conduits tend to be at a significantly lower temperature than the heating chamber to which they are connected. Such collected condensate may, in some cases, leak out of the device, leading to a less pleasant user experience. In addition, or instead, such condensate may dry out over time, potentially forming a gum on the interior surfaces of the conduits. This gum can be difficult to remove and can therefore agglomerate over time. Furthermore, where the aerosol-generating material is contained within a consumable, the gum may adhere to the consumable, potentially discoloring it or hindering its removal after use.

An aerosol provision device may therefore be configured such that that the interior surface of a given conduit is heated during a session of use, so that the accumulation of condensate within the conduit in question may be limited and, in some cases, substantially prevented. In particular, the deposition of condensate on the interior surfaces of the conduit may be reduced.

It is common in aerosol provision devices for insulation to be provided around the heating chamber in order to protect users and device electronic components from the heat generated. It will be appreciated that where conduits in the aerosol provision device are also being heated, thermal insulation of those components would also be beneficial. This disclosure addresses the provision of such thermal insulation in an effective and efficient way in the context of also thermally insulating the heating chamber.

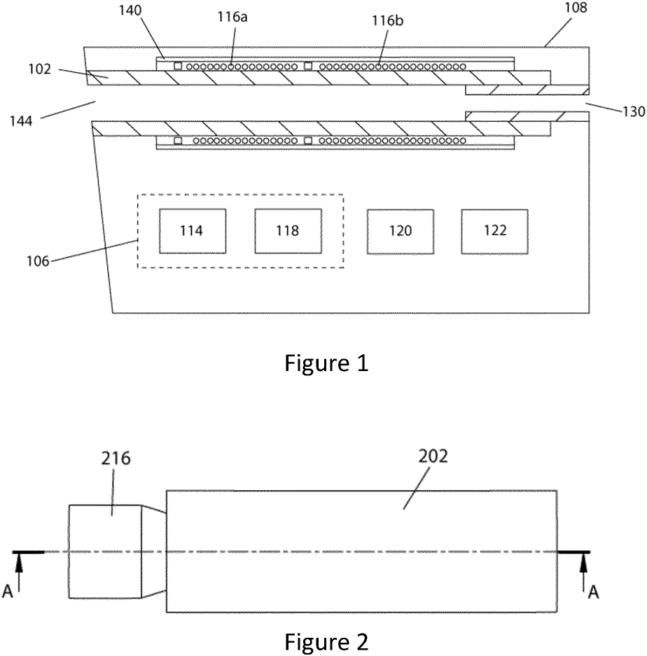

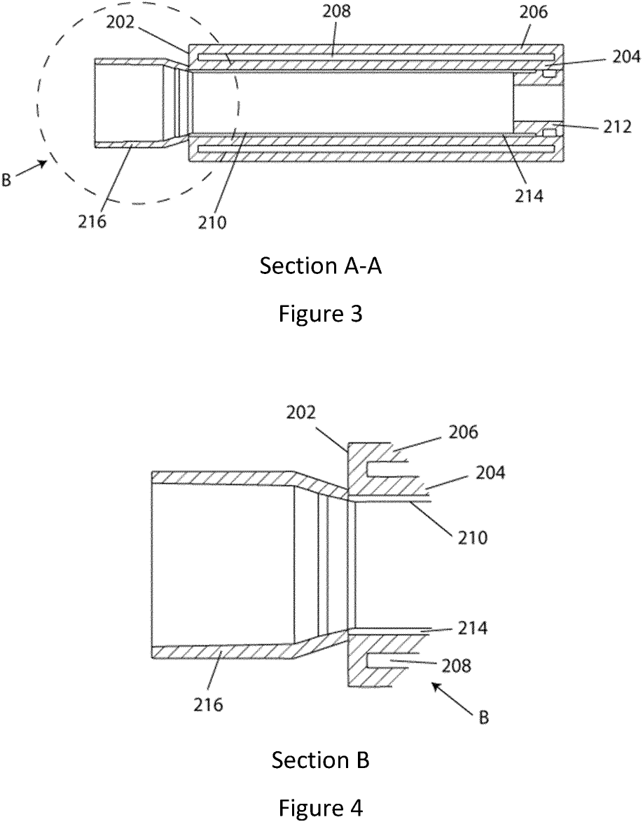

FIG. 1 shows a schematic cross-sectional view of an aerosol provision device 100 according to an example of the disclosure. FIGS. 2 and 3 show schematic views of an example thermal insulator 102 for use in the aerosol provision device 100. The thermal insulator 102 is shown in simplified form in FIG. 1, for clarity. The thermal insulator 102 of the aerosol provision device 100 is configured for receiving aerosol-generating material (not shown) that is to be heated, in that it comprises a heating chamber or zone 144. The aerosol-generating material, which could be provided within a consumable article or “consumable”, is insertable into an opening of the heating chamber 144 in the aerosol provision device 100. The aerosol provision device 100 includes a magnetic field generator 106 for generating a varying magnetic field, in use, and a housing 108 for housing each of the components of the aerosol provision device 100.

In this example, the magnetic field generator 106 comprises an electrical power source 114 and a device 118 for passing a varying electrical current, such as an alternating current, through a coil. In the example illustrated in FIG. 1, the coil is a two-part coil 116a, 116b. In some examples, such as that illustrated in FIG. 1, the magnetic field generator 106 is also connected to a controller 120 and a user interface 122 for user operation of the controller 120.

The electrical power source 114 may be a rechargeable battery (such as a lithium ion battery), a non-rechargeable battery, a capacitor, a battery-capacitor hybrid, or a connection to a mains electricity supply.

The coil 116a, 116b may take any suitable form, including the form of a single coil with two portions; a single portion coil is also possible as an alternative. In the example illustrated in FIG. 1, the two-part coil 116a, 116b is a helical coil made of an electrically conductive material, such as copper. In some examples, the coil 116a, 116b may be a flat coil. That is, the coil may be a pseudo two-dimensional spiral. In some examples, the coil may comprise a Litz wire.

The aerosol provision device 100 includes an inlet conduit 130 that fluidly connects an interior of the apparatus with an exterior of the housing 108 of the aerosol provision device 100 so that air can be drawn into the device 100. In use, a user is able to inhale a volatilized component(s) of the aerosol-generating material by drawing on a consumable article containing the aerosol-generating material. As the volatilized component(s) is/are removed from the aerosol-generating material, air is drawn into the aerosol provision device 100 via the inlet conduit 130.

The thermal insulator 102 is illustrated in more detail in FIGS. 2 to 7. The example thermal insulator 102 shown in FIGS. 1-7 comprises an outer wall, an inner wall and an insulation region bound by the inner wall and the outer wall, wherein the insulation region is evacuated to a lower pressure than an exterior of the insulation region. In practice, the pressure exterior to the insulation region is atmospheric pressure in almost all cases. Providing an insulation region which is at a pressure lower than atmospheric pressure thermally insulates the heating chamber/zone 144 from the outer wall and the housing 108, thereby limiting heat transfer away from the heating chamber/zone 144 into the rest of the aerosol provision device 100, exterior to the heating chamber/zone 144. This is advantageous because other components of an aerosol provision device 100, such as the electrical power source 114, may be sensitive to increases in temperature. It is well-known, for example, that batteries and other electronic circuitry may be damaged or even dangerous if exposed to high temperatures. Furthermore, heat transfer to the housing 108 of the aerosol provision device 100 may cause discomfort or even injury to the user, in use.

FIG. 2 illustrates an external schematic view of a thermal insulator 202 according to a first aspect of the present disclosure, and a hollow chamber 216, the thermal insulator 202 and the hollow chamber 216 being component parts of the aerosol provision device 100. The hollow chamber 216 is discussed in further detail below.

FIG. 3 shows a section A-A through the thermal insulator 202 illustrated in FIG. 2. FIGS. 2, 3 and 4 are not drawn to scale. The thermal insulator 202 comprises an inner wall 204 and an outer wall 206. The inner wall 204 and the outer wall 206 surround an insulation region 208, wherein the insulation region is evacuated to a lower pressure than an exterior of the insulation region 208. The inner wall 204 and the outer wall 206 may be bonded together by any suitable means, for example: welding, braising, or adhered to one another with an adhesive. The pressure in the insulation region 208 may be in the range of 10⁻¹ to 10⁻⁷ torr; a pressure of 10⁻³ torr or lower is considered to be particularly advantageous. In some examples, the pressure in the insulating region 208 is considered to be a vacuum. The inner wall 204 and the outer wall 206 of the thermal insulator 202 are sufficiently strong to withstand any force exerted against them due to the pressure differential between the insulation region 208 and regions external to the insulation region 208, thereby preventing the thermal insulator 202 from collapsing inwards. A gas-absorbing material may be used in the insulation region 208 to maintain or aid creation of a relatively low pressure in the insulation region 208.

Providing an insulation region 208 at a pressure lower than atmospheric pressure is particularly advantageous because it allows for very effective thermal insulation to be provided in an area which is much smaller in size than may be possible with alternative thermal insulation options. This in turn allows for the overall size of the aerosol provision device 100 to be kept to a minimum, without compromising the thermal insulation of the heating chamber/zone 144.

The section of the aerosol provision device 100 illustrated in FIG. 3 further comprises a first heating element 210 and a second heating element 212. The first heating element 210 and the second heating element 212 may be joined by any suitable means, such as welding, braising, by means of an adhesive or by an interference fit. Alternatively, they may simply abut one another or be arranged adjacent to one another. In the example illustrated in FIG. 3, the first heating element 210 defines the heating zone into which aerosol-generating material (not shown) is inserted, in use. The second heating element 212 may comprise, for example, at least part of an inlet conduit 130, which fluidically connects the heating chamber defined by the first heating element 210 with the exterior of the device 100. In use, air is drawn into the device 100, flowing along the inlet conduit 130 at least partly defined by the second heating element 212, prior to flowing into the heating chamber 144 which is defined by the first heating element 210. As discussed previously, the second heating element 212 limits the accumulation of condensate that may form in the inlet conduit 130 during a session of use by warming the inlet conduit 130. It should be understood that while the example illustrated in FIG. 3 shows the first heating element 210 as an elongated tubular member, and the second heating element 212 as a shorter tubular member located axially at one end of the first heating member 210, the terms ‘first’ and ‘second’ should be considered merely as arbitrary labels and do not preclude the possibility of alternative arrangements, relative positions and relative sizes of such members.

In FIG. 3, the thermal insulator 202 is shown as extending along the entire length of the first heating element 210. However, in an alternative example the thermal insulator 202 may extend only partially along a length of the first heating element 210. That is, the thermal insulator 202 may extend along only a portion of the first heating element 210, such that thermal insulation may be provided around only a portion of the first heating element 210. Providing a thermal insulator 202 that extends only part of the way along the length of the first heating element 210 could allow for the overall size of the aerosol provision device 100 to be further reduced. The thermal insulator 202 and the first heating element 210 are shown as being co-axial with one another, although this is not essential. It should be understood that each of the statements in this paragraph regarding the first heating element 210 may also apply in a similar way to the second heating element 212, although it is emphasized that the thermal insulator 102 extends around at least a part of the first heating element 210 and at least a part of the second heating element 212 in all cases. By extending around at least a part of the first heating element 210 and at least a part of the second heating element 212, the thermal insulation 202 is able to reduce unwanted heat transfer to other components of the device 100. This is beneficial because, as discussed above, transferring heat into other areas of the device 100 could cause damage to other components and possibly even injury to a user. A thermal insulator 202 comprising a low-pressure region is rendered ineffective if damage or fatigue causes external atmosphere to leak into the insulation region 208, such that the pressure is raised to a normal atmospheric level. By extending around at least part of both the first heating element 210 and the second heating element 212 with a single thermal insulation component 202 continuous across both heating elements, the reliability of the thermal insulation of the aerosol provision device is improved, by reducing the number of components that could suffer a failure. Furthermore, manufacturing a thermal insulator 202 comprising an evacuated insulation region 208 is known to be technically challenging; therefore, by providing a single thermal insulator 202 that reduces thermal transfer from both the first heating element 210 and the second heating element 212 will reduce the complexity of the manufacturing process.

In some examples, the thermal insulator 102 extends around at least part of the first heating element 210 and at least part of the second heating element 212 such that the thermal insulator 102 surrounds at least part of the first heating element 210 and the and second heating elements 212. By surrounding at least part of the first heating element 210 and the second heating element 212, the reduction of unwanted heat transfer to other components of the device 100 may be improved.

In some examples, the first heating element 210 is heatable by penetration with a varying magnetic field. Heating by penetration with a varying magnetic field is advantageous because heat is generated inside the object itself, rather than by an external heat source by heat conduction, and so a rapid temperature rise in the object and more uniform heat distribution can be achieved. This may be further improved through selection of suitable object material and geometry, and suitable varying magnetic field magnitude and orientation relative to the object. Moreover, as heating by penetration with a varying magnetic field does not require a physical connection to be provided between the source of the varying magnetic field and the object, design freedom and control over the heating profile of the first heating element 210 may be greater, and cost may be lower. In one example, the first heating element 210 may be formed of mild steel. Mild steel is inexpensive, easily workable and is a susceptor. Suitable grades of mild steel are, for example, SPCE steel or 1010 grade steel. In another example, the first heating element 210 may be formed of ferritic stainless steel. Ferritic stainless steel is easily workable, has good corrosion resistance and is a susceptor. A nickel-cobalt ferrous alloy, such as Kovar®, could also be used as an alternative.

In some examples, the second heating element 212 is also heatable by penetration with a varying magnetic field. In examples where the second heating element 212 is heatable by penetration with a varying magnetic field, the second heating element 212 may also be formed of mild steel, such as SPCE steel or 1010 grade steel, or from ferritic stainless steel. As with the first heating element 210, Kovar® is an alternative suitable material for the second heating element 212.

In some examples, the first heating element 210 and/or the second heating element 212 are heatable by resistive heating. This may be additional, or as an alternative, to heating by penetration with a varying magnetic field. In examples where only one of the first heating element 210 or second heating element 212 is heatable by penetration with a varying magnetic field, the other heating element may be heatable by conduction of heat from the element heatable by penetration with a varying magnetic field, or independently resistively heated. This has the advantage that the varying magnetic field applied during heating would only need to be configured such that one of the heating elements is penetrated by the varying magnetic field; this could reduce the size and/or complexity of the aerosol provision device. The materials requirements for a heating element to be resistively heated or heated by conduction are less restrictive than for a heating element heatable by penetration with a varying magnetic field. For example, a heating element heatable resistively or by conduction could comprise metals such as austenitic stainless steel or aluminum; austenitic stainless steel is inexpensive, easy to form and has excellent corrosion resistance properties, whereas aluminum is lightweight, corrosion-resistant and easily machinable. Austenitic stainless steel and aluminum are not heatable by penetration with a varying magnetic field. We note here that the phrase ‘not heatable by penetration with a varying magnetic field’ should be understood to mean that any heat generated in such a material when penetrated with a varying magnetic field is negligible when compared with a material that is readily heatable by penetration with a varying magnetic field, such as mild steel. Considering heating by conduction, specifically, that is when one heating element is heated through contact with the other or via a connecting thermally conductive component (the other heating element being heated resistively or inductively), other materials are also suitable as heating element materials. Ceramic and glass materials, for example, can have good thermal conduction properties.

In examples where the first heating element 210 and/or the second heating element 212 comprise a metallic material, the metal may be coated with a corrosion-resistant coating. For example, in examples where mild steel is used, a nickel plating may be applied to the mild steel. This is beneficial because surface oxidation (i.e. rust in the case of an iron-based metal) may result in degraded thermal performance. For example, surface oxidation may act as a thermal insulator, reducing the efficiency with which the heating element is able to transmit heat to the consumable as intended. The presence of an oxidation layer can also negatively affect the sensory experience for the user.

In some examples, the materials of the first heating element 210 and the second heating element 212 are selected to have a similar coefficient of thermal expansion. This is beneficial in reducing mechanical stress on each component during any high temperature manufacturing processes, such as braising or welding, and during repeated heating and cooling cycles which are applied to the heating elements in the aerosol provision device 100 in use.

In some examples, an air gap 214 may be present between the inner wall 204 of the thermal insulator 202 and the first heating element 210. Alternatively, or additionally, an air gap 214 may be present between the inner wall 214 and the second heating element 212. An air gap 214 helps to improve the thermal insulation provided by the thermal insulator, by reducing conductive heat transfer from the first heating element 210 and/or the second heating element 212 to the inner wall 204 of the thermal insulator 202. Reducing the conductive heat transfer by providing an air gap 214 may also be advantageous as it could allow for a material to be used for the inner wall 204 that has advantageous properties, but would be damaged or degraded by direct contact with the first heating element 210 and/or the second heating element 212.

In some examples, the inner wall 204 and the outer wall 206 of the thermal insulator 202 comprise thermally insulating materials. In some examples, the inner wall 204 and outer wall 206 are formed from non-susceptible and electrically non-conductive materials, such that the inner wall 204 and the outer wall 206 will not be significantly heated by induction heating when exposed to a varying magnetic field. Providing an inner wall 204 and an outer wall 206 of non-susceptible materials means that, when a varying electrical current, such as an alternating current, is passed through the coil 116a, 116b, the thermal insulator 202 will not be heated by induction heating. Therefore, the efficiency of the system and the thermal management within the system can be improved, as energy will not be wasted heating the thermal insulator 202 and excessive temperature rises in the inner wall 204 and outer wall 206 will not need to be controlled and/or mitigated. If the inner wall 204 and outer wall 206 were to be heated by virtue of an applied varying magnetic field, the first heating element 210 and/or second heating element 212 may in fact only be heated minimally, which would be undesirable. This arrangement also serves to keep an outside temperature of the housing 108, particularly at its surface, at an acceptable level for handling by a user.

In some examples, the inner wall 204 and the outer wall 206 are formed from materials with low thermal conductivity, such that heat is not readily conducted through the materials of the thermal insulator. In some examples, the inner wall 204 and outer wall 206 comprise materials that are non-porous to reduce the rate at which external atmosphere may leak into the insulation region 208, in use. In some examples, the inner wall 204 and the outer wall 206 comprise one or more of: metal, a non-porous plastic, glass or ceramic material. Metal is inexpensive, easily workable and has good mechanical properties, plastic is inexpensive, easily formable and tough; glass is inexpensive, easily formable and has good strength, whereas ceramic materials are inexpensive, strong, tough and lightweight. A suitable plastic material could be a polymer which is thermally and mechanically stable up to at least 250° C., possibly to at least 320° C.; an example of such a polymer is polyether ether ketone (PEEK). A suitable glass material could be borosilicate glass, which has a low coefficient of thermal expansion, making it particularly resistant to thermal shock. A suitable ceramic material could be zirconia. A composite material comprising more than one of the materials listed above, such as a glass reinforced plastic, may allow for the beneficial properties of the materials to be combined.

The inner wall 204 and the outer wall 206 may comprise the same material, or different materials. Using the same material allows for the inner wall 204 and outer wall 206 to be joined to one another more easily, thus reducing manufacturing complexity. Alternatively, if different materials are used for the inner wall 204 and the outer wall 206, the materials for each of the inner wall 204 and the outer wall 206 can be selected to more specifically address the particular requirements of each component. For example, the inner wall 204 is located closer to the first heating element 210 and the second heating element 212 than the outer wall 206, and thus the inner wall 204 material may require a higher tolerance to temperature and/or thermal cycling than that of the outer wall 206. The outer wall 206, in contrast, is unlikely to be directly exposed to temperatures as high as those at the inner wall 204 and thus a material with improved mechanical properties but less thermal stability could be selected, for example.

As noted above, FIG. 3 further illustrates a hollow chamber 216 extending axially from one end of the first heating element 210 and connected with the heating chamber 144. The hollow chamber 216 is arranged such that if a consumable comprising aerosol-generating material is inserted into the heating zone/chamber 144 defined by the first heating element 210, the hollow chamber 216 surrounds at least a portion of the consumable, and the inner wall of the hollow chamber 216 and the at least a portion of the consumable define an air channel therebetween (not shown in FIG. 3). In some examples, the hollow chamber 216 comprises at least a part of the first heating element 210 or the second heating element 212. Alternatively, or additionally, the hollow chamber 216 may be formed integrally with the first heating element 212 or the second heating element 212, or the hollow chamber 216 may simply abut the first heating element 212 or the second heating element 212 or be arranged adjacent to first heating element 212 or the second heating element 212. In examples where the hollow chamber 216 comprises or is joined to at least part of the first heating element 210 or second heating element 212, the material requirements for the hollow chamber 216 are similar to those of the first heating element 210 and the second heating element 212. In such examples, the material chosen for the hollow chamber 216 is selected to have a similar coefficient of thermal expansion to the first heating element 210 and/or second heating element 212, or alternatively the material chosen may be selected to be tolerant to thermal and mechanical stresses that may be introduced to the hollow chamber 216 by the heating elements 210, 212. In examples where the hollow chamber 216 is joined to the first heating member 210 or the second heating member 212, the joining may be achieved by welding, braising, by means of an adhesive or by an interference fit.

FIG. 4 is an expanded view of section B identified in FIG. 3. The expanded view illustrated in FIG. 4 more clearly shows the arrangement of the first heating element 210, the thermal insulator 202 and the hollow chamber 216, as illustrated in FIG. 3. The air gap 214 illustrated in FIG. 3, and discussed in detail above, is also shown more clearly in FIG. 4, located between the first heating element 210 and the inner wall 204 of the insulator 206.

The air channel (not shown) defined by the inner wall of the hollow chamber 216 and the consumable may be in fluid communication with a region exterior to the housing 108 of the apparatus 100. In such an example, a fluid communication pathway between the air channel defined by the inner wall of the hollow chamber 216 and the region external to the housing 108 of the apparatus 100 does not extend into the heating zone defined by the first heating element 210. Such a fluid communication pathway may, for example, allow heated volatilized components that escape the consumable article through its outer wrapper to flow safely out of the apparatus 100 without being inhaled by a user or re-entering the heating chamber 144. The fluid communication pathway may additionally allow for cool air to enter the air channel. In order to improve the ventilation capability of the air channel defined by the inner wall of the hollow chamber 216 and the consumable, the fluid communication pathway can be divided into multiple ventilation pathways extending circumferentially around the inner wall of the hollow chamber 216 by including protrusions around an inner surface of the hollow chamber 216.

In examples where the hollow chamber 216 does not comprise the first heating element 210 or the second heating element 212, the materials requirements for the hollow chamber 216 may be similar to those of the outer wall 206, as discussed above.

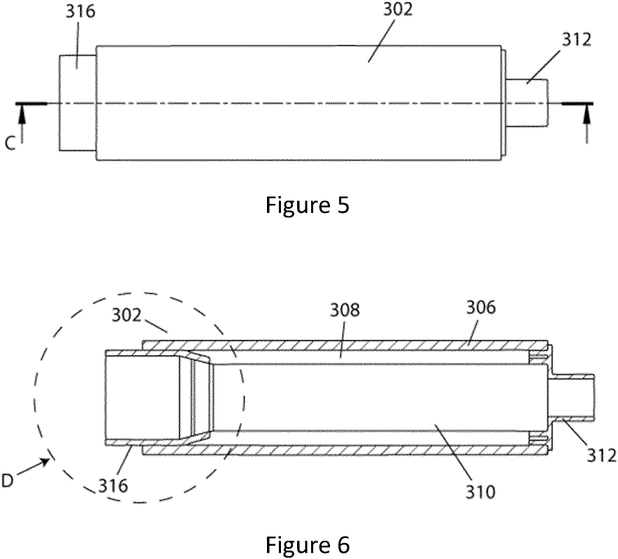

FIG. 5 illustrates an external schematic view of an example of a thermal insulator 302 according to a second aspect of the present disclosure, the thermal insulator 302 also being part of the aerosol provision device 100, as an alternative to the thermal insulator 202. FIG. 5 also illustrates a hollow chamber 316.

FIG. 6 shows a section C-C through the thermal insulator 302 illustrated in FIG. 2. FIGS. 5, 6 and 7 are not drawn to scale. Like the thermal insulator 202 discussed above, the thermal insulator 302 comprises an inner wall and an outer wall 306; however, the inner wall comprises at least part of each of the first heating element 310 and the second heating element 312. As the inner wall functions as a first heating element 310, a second heating element 312 and a wall of the thermal insulator 302, the overall size and weight of the aerosol provision device 100 can be reduced as there is no requirement to include separate heating elements and a separate insulation component. Similar to the thermal insulator 202 described above, the inner wall and the outer wall 306 surround an insulation region 308, wherein the insulation region is evacuated to a lower pressure than an exterior of the insulation region 308. As with the thermal insulator 202 discussed above, the first heating element 310 and the second heating element 312 may be joined by any suitable means. However, as the first heating element 310 and the second heating element 312 comprise at least part of the inner wall, the means for joining the first heating element 310 and second heating element 312 must be suitable for preventing external atmosphere from leaking into the insulation region. In some examples, the first heating element 310 and the second heating element 312 are integral with one another. The pressure in the insulation region 308 may be in the range of 10⁻¹ to 10⁻⁷ torr; a pressure of 10⁻³ torr or lower is considered to be particularly advantageous. In some examples, the pressure in the insulating region 308 is considered to be a vacuum. The components comprising the inner wall and the outer wall 306 of the thermal insulator 302 are sufficiently strong to withstand any force exerted against them due to the pressure differential between the insulation region 308 and regions external to the insulation region 308, thereby preventing the thermal insulator 302 from collapsing inwards. A gas-absorbing material may be used in the insulation region 308 to maintain or aid creation of a relatively low pressure in the insulation region 308.

In the example shown in FIG. 6, the second heating element 312 is joined to the outer wall 306 in order to enclose the insulation region 308. In such examples, the second heating element 312 is joined to the outer wall 306 by any suitable means, such as welding, braising or with an adhesive. As with the joining between the first heating element 310 and the second heating element 312 discussed above, the means for joining the second heating element 312 and the outer wall 306 must be suitable for preventing external atmosphere from leaking into the insulation region 308. This particular arrangement may not be present in all examples of the second aspect of this disclosure. For example, the second heating element 312 may be joined to a hollow chamber 316 and a first heating element 310, with each of the hollow chamber 316 and the first heating element 310 being joined to the outer wall 306 in order to enclose the insulation region. It should be understood that in all examples, any join formed between components that enclose the insulation region should be selected such that the join is suitable for preventing external atmosphere from leaking into the insulation region 308.

The example illustrated in FIG. 6 shows that the first heating element 310 and the outer wall 306 enclose a portion of the hollow chamber 316 and that the hollow chamber 316 is one of the components captured within and closing the insulation region 308. Such an arrangement is merely an example of one possible option according to the second aspect of the present disclosure. It should be understood that the hollow chamber 316 may not be included in this way in some examples. Furthermore, in some examples where the hollow chamber 316 is included, the outer wall 306 may be joined directly to the first heating element 310 such that the hollow chamber 316 does not protrude into the insulation region 308. This may be advantageous as it reduces the number of components involved in containing the insulation region 308. This may also simplify the manufacturing process and may help to prevent external atmosphere from leaking into the insulation region 308 during the lifetime of the aerosol provision device 100.

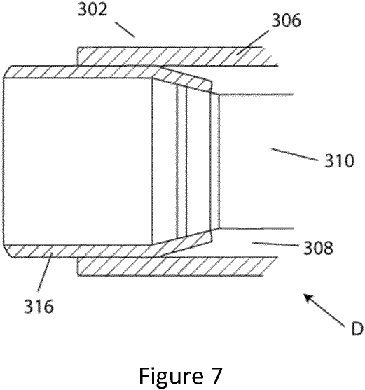

FIG. 7 is an expanded view of section D identified in FIG. 6. The expanded view illustrated in FIG. 7 more clearly shows the arrangement of the first heating element 310, the outer wall 306 and the hollow chamber 316, as illustrated in FIG. 6. The insulation region 308 illustrated in FIG. 6, and discussed in detail above, is also shown more clearly in FIG. 7, located in this example between the first heating element 310 the outer wall 306 and a portion of the hollow chamber 316.

Returning to FIG. 6, the outer wall 306 is shown as extending along the entire length of the first heating element 310. However, in an alternative example, the outer wall 306 may extend only partially along a length of the first heating element 310. That is, the outer wall 306 may extend along only a portion of the first heating element 310, such that thermal insulation may be provided around only a portion of the first heating element 310. Providing an outer wall 306 that extends only part of the way along the length of the first heating element 310 could allow for the overall size of the aerosol provision device 100 to be further reduced. The outer wall 306 and the first heating element 310 are shown as being co-axial with one another, although this is not essential. It should be understood that each of the statements in this paragraph regarding the first heating element 310 may also apply in a similar way to the second heating element 312. However, in all examples the outer wall 306 extends around at least part of the first heating element 310 and the second heating element 321, regardless of the particular arrangement of the heating elements and the outer wall 306.

As with the thermal insulator 202 discussed above, the first heating element 310 and the second heating element 312 may be heated as discussed above, i.e. by penetration by a varying magnetic field, by resistive heating and/or by conduction. The materials requirements for the first heating element 310 and the second heating element 312 are similar to those discussed above, with the extra requirement that the materials chosen must be capable of preventing ingress of external atmosphere into the insulation 308; for example, they must be non-porous. Furthermore, the materials chosen must have sufficient strength to withstand any force exerted against the first heating element 310 and the second heating element 312 due to the pressure differential between the insulation region 308 and regions external to the insulation region 308, thereby preventing the thermal insulator 302 from collapsing inwards.

The materials requirements for the outer wall 306 are similar to those of the outer wall 206 discussed above. The inner wall should be made from a susceptible material and/or an electrically conductive material. The materials requirements for the hollow chamber 316 are similar to those of the hollow chamber 216 discussed above, with the extra requirement that in examples where at least a portion of the hollow chamber 316 is involved in enclosing the insulation region 308, the materials chosen must be capable of preventing ingress of external atmosphere into the insulation 308; for example, they must be non-porous.

A third aspect of the present disclosure describes an aerosol provision system, comprising: an apparatus according to the first or second aspect of the present disclosure; and aerosol-generating material located at least partially within the heating zone of the inner wall of the thermal insulator, in use.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A non-combustible aerosol provision device for heating aerosol-generating material to volatilize at least one component of the aerosol-generating material, the non-combustible aerosol provision device comprising:
a first heating element at least partially defining a heating zone for receiving at least a portion of a consumable comprising the aerosol-generating material;
a second heating element extending from an axial end of the first heating element beyond the heating zone; and
a thermal insulator comprising:
an inner wall,
an outer wall, and
an insulation region bound by the inner wall and the outer wall, wherein the insulation region is evacuated to a lower pressure than an exterior of the insulation region,
the thermal insulator being arranged to extend around at least part of the first heating element and at least part of the second heating element.

2. The non-combustible aerosol provision device according to claim 1, wherein the thermal insulator is arranged to surround at least part of the first heating element and at least part of the second heating element.

3. The non-combustible aerosol provision device according to claim 1, wherein an air gap is present between the inner wall of the thermal insulator and the first heating element.

4. The non-combustible aerosol provision device according to claim 1, wherein an air gap is present between the inner wall of the thermal insulator and the second heating element.

5. The non-combustible aerosol provision device according to claim 1, wherein the inner wall of the thermal insulator is not heatable by penetration with a varying magnetic field.

6. The non-combustible aerosol provision device according to claim 5, wherein the inner wall comprises one or more of: metal, glass, ceramic or plastic.

7. The non-combustible aerosol provision device according to claim 6, wherein the inner wall comprises a polymer with a melting point of at least 250° C.

8. A non-combustible aerosol provision device for heating aerosol-generating material to volatilize at least one component of the aerosol-generating material, the non-combustible aerosol provision device comprising:
a first heating element at least partially defining a heating zone for receiving at least a portion of a consumable comprising the aerosol-generating material;
a second heating element extending from an axial end of the first heating element beyond the heating zone;
a thermal insulator comprising:
an inner wall,
an outer wall, and
an insulation region bound by the inner wall and the outer wall, wherein the insulation region is evacuated to a lower pressure than an exterior of the insulation region, and wherein the inner wall comprises at least a part of each of the first heating element and the second heating element.

9. The non-combustible aerosol provision device according to claim 1, wherein the insulation region is evacuated to a pressure of 10⁻³ Torr or lower.

10. The non-combustible aerosol provision device according to claim 1, wherein the outer wall of the thermal insulator comprises a material that is not heatable by penetration with a varying magnetic field.

11. The non-combustible aerosol provision device according to claim 1, wherein the outer wall comprises one or more of: metal, glass, ceramic or plastic.

12. The non-combustible aerosol provision device according to claim 11, wherein the outer wall comprises a polymer with a melting point of at least 250° C.

13. The non-combustible aerosol provision device according to claim 1, wherein at least one of the first heating element or the second heating element is heatable by conduction.

14. The non-combustible aerosol provision device according to claim 1, wherein at least one of the first heating element or the second heating element is heatable by penetration with a varying magnetic field.

15. The non-combustible aerosol provision device according to claim 14, further comprising a magnetic field generator for generating a varying magnetic field that penetrates at least one of the first heating element or the second heating element in order to heat the at least one of the first heating element or the second heating element elements, in use.

16. The non-combustible aerosol provision device according to claim 1, wherein at least one of the first heating element or the second heating element comprises mild steel or ferritic stainless steel.

17. The non-combustible aerosol provision device according to claim 1, wherein at least one of the first heating element or the second heating element is treated with a corrosion-resistant coating.

18. The non-combustible aerosol provision device according to claim 1, further comprising a hollow chamber extending from an axial end of the first heating element, the hollow chamber surrounding at least a portion of the consumable when the consumable is inserted into the non-combustible aerosol provision device, and wherein an inner wall of the chamber and the at least the portion of the consumable define an air channel there between.

19. The non-combustible aerosol provision device according to claim 18, wherein the hollow chamber comprises the first heating element or the second heating element.

20. (canceled)

21. (canceled)

22. A non-combustible aerosol provision system, comprising:
the non-combustible aerosol provision device of claim 1; and
the aerosol-generating material located at least partially within the heating zone of at least one of the first heating element or the second heating element, in use.
